(19) United States
(12) Patent Application Publication
(10) Pub. No.: US 2026/0154400 A1
(43) Pub. Date: Jun. 4, 2026

(54) TIER-BASED ALERT THROTTLING

(71) Applicant: Microsoft Technology Licensing, LLC, Redmond, WA (US)

(72) Inventors: Emil GELMAN, Haifa (IL); Idan GUTMAN, Givatayim (IL); Sunders BRUSKIN, Ramla (IL)

(21) Appl. No.: 18/963,939

(22) Filed: Nov. 29, 2024

(51) Int. Cl. G06F 21/55

(52) U.S. Cl. CPC G06F 21/55; G06F 2221/034

(57) ABSTRACT

Systems, methods, and computer program products are disclosed for tiered approach to alert throttling. A set of identifiers is extracted from an alert. The set of identifiers are respectively analyzed in a set of throttling tiers corresponding to the set of identifiers to determine whether the alert satisfies a set of throttling conditions. If the alert does not satisfy the set of throttling conditions, the alert is provided to an alert recipient. If the alert satisfies a throttling condition of the set of throttling conditions, the alert is throttled and is not provided to the alert recipient.

### BACKGROUND

Alert throttling is the process of regulating the volume and frequency of security alerts generated by monitoring systems that monitor computer systems. The primary purpose of alert throttling is to limit the volume and/or frequency of alerts in order to reduce noise and/or avoid alert fatigue, especially in systems that generate numerous notifications. Alert throttling helps ensure efficient resource allocation by prioritizing important alerts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are disclosed for tiered approaches to alert throttling. An alert is analyzed with respect to a set of throttling tiers to determine whether the alert should be throttled based on rules associated with the throttling tiers. This tier-based approach to alert throttling offers greater flexibility and control for fine tuning of alert throttling rules. For instance, each throttling tier can be tuned to address different scenarios within the alert.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for throttling alerts using throttling tiers, in accordance with an embodiment.

FIG. 2 shows a block diagram of an example system for key-based throttling of alerts using throttling tiers, in accordance with an embodiment.

FIG. 3 shows a flowchart of an example process for key-based throttling of alerts using throttling tiers, in accordance with an embodiment.

FIG. 4 shows a flowchart of an example process for checking alert throttling conditions using a distributed service, in accordance with an embodiment.

FIG. 5 shows a flowchart of an example process for determining whether an alert throttling condition is satisfied, in accordance with an embodiment.

FIG. 6 depicts a flowchart of an example process for incrementing alert throttling counters, in accordance with an embodiment.

FIG. 7 shows a flowchart of an example process for throttling alerts associated with a throttling tier, in accordance with an embodiment.

FIG. 8 shows a flowchart of an example process for extracting keys from an alert, in accordance with an embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Alert throttling is used to limit the number of alerts triggered for a computing system (e.g., a set of servers, storage devices, networking devices, etc.) within a given period to reduce noise and avoid alert fatigue. When an alert condition is met, throttling prevents repetitive alerts from flooding the system or alert recipients. Alert throttling in real-time environments is both crucial and challenging. In such environments, improper alert throttling can introduce significant risks. For example, over-throttling might suppress critical alerts, leading to false negatives where throttled alerts should have been sent, and causing major issues to be missed. On the other hand, under-throttling can cause a flood of false positives where alert recipients are overwhelmed with alerts concerning minor issues. The increase in alerts concerning minor issues creates noise that can lead the alert recipients to miss critical alerts that are lost in the noise.

Tier-based alert throttling offers greater flexibility and control for fine tuning alert throttling rules at a greater level of granularity. For example, different throttling tiers are configured with different alert throttling rules to address different alert scenarios that are specific to the throttling tier. In embodiments, the throttling rules associated with this first throttling tier limit the number of alerts that are transmitted during a predetermined duration of time.

Any number of throttling tiers may be created to address corresponding issues. For instance, in embodiments, a first throttling tier is created to focus on addressing alert scenarios associated with major issues that could overwhelm the alert system, such as, but not limited to, a flood of alerts caused by a new application and/or changes in data patterns. These alert scenarios can generate a high volume of alerts in a short period time, potentially leading to system instability and/or alert fatigue. In this first throttling tier, throttling is applied at a high-level, such as, but not limited to, a cluster-level, resource group-level, and/or an organization-level. In embodiments, alert throttling in this first tier is configured such that the duration of time for throttling is based on the time required to resolve the root cause of an issue, which is typically the time it takes to update the detection logic or fix the underlying problem. This first throttling tier ensures that large-scale issues are blocked immediately to prevent further escalation.

In embodiments, a second throttling tier focuses on addressing alert scenarios associated with recurring system behaviors or harmless activities. By controlling the number of alerts triggered by known benign conditions, the number of false positive alerts can be reduced without increasing the number of false negative alerts. In embodiments, this second throttling tier is configured based on specific keys (e.g., workload identifier, etc.), timeframes, and/or alert thresholds to ensure that only known benign conditions are filtered out. In embodiments, the throttling rules for this second throttling tier are generated based on known recurring patterns that trigger alerts concerning minor issues. This second throttling tier mitigates recurring false positive alerts by applying throttling rules that reflect the unique behavior of a particular environment and/or scenario. By controlling the number of alerts triggered by known benign conditions, this second throttling tier reduces noise without missing genuine threats.

In embodiments, a third throttling tier focuses on addressing alert scenarios that trigger disruptions, such as, but not limited to, terminating a process, terminating a pod, and/or the like. In this third throttling tier, alert throttling is applied at a fine level of granularity, where disruption of specific entities (e.g., a container, an instance, a process, etc.) is required. In embodiments, alerts that reach this third throttling tier will trigger direct disruption actions to swiftly mitigate any potential threats. In addition, this third throttling tier, in embodiments, focuses on identifying a particular security incident to allow investigation teams to understand the deepest resolution of the alert, such as, but not limited to, identifying a malicious process. In embodiments, alert throttling at this third throttling tier is applied at a fine level of granularity.

In embodiments, throttling tiers are each assigned identifying and/or other information, such as a tier name, a permit limit that limits the number of alerts that may be transmitted on the tier, and a time window that defines a time period during which the number of alerts may be transmitted. In embodiments, alerts are throttled by a throttling tier based on a key or identifier that is extracted from the alerts. For example, alerts include a set of identifiers, such as, but not limited to, a cluster-level identifier, a workload-level identifier, and/or a container-level identifier that are mapped to a cluster-level throttling tier, a workload-level throttling tier, and a container-level throttling tier. In embodiments, at a cluster-level throttling tier, alerts are throttled based on a cluster-level identifier extracted from the alerts, where the number of alerts associated with a particular cluster-level identifier is limited based on the permit level and time window associated with the cluster-level throttling tier. In embodiments, at a workload-level throttling tier, alerts are throttled based on a workload-level identifier extracted from the alerts, where the number of alerts associated with a particular workload-level identifier are limited based on the permit level and time window associated with the workload-level throttling tier. In embodiments, at a container-level throttling tier, alerts are throttled based on a container-level identifier extracted from the alerts, where the number of alerts associated with a particular container-level identifier are limited based on the permit level and time window associated with the container-level throttling tier.

In embodiments, subject matter experts define sets of throttling tiers based on alert types. For instance, for a particular type of alert, subject matter experts define a mapping that maps a set of keys or identifiers to a corresponding set of throttling tiers. In embodiments, the subject matter experts define the set of throttling tiers by defining a throttling tier name, a permit limit that limits the number of alerts that may be transmitted on the tier, and a time window that defines a time period during which the number of alerts may be transmitted. For instance, a subject matter expert can define a set of throttling tiers for alerts associated with a container orchestration system that includes a cluster-level throttling tier that permits 20 alerts per day, a workload-level throttling tier that permits 5 alerts per hour, and/or a container-level throttling tier that permits 1 alert per day (or any other appropriate number of alerts per time period).

In embodiments, an alert type associated with an alert determines the mapping used to extract keys or identifiers from the alert. For instance, a mapping associated with a particular type of alert is used to parse the alert in order to extract a set of keys or identifiers from the alert. Once the set of keys or identifiers is extracted from the alert, the alert is, in embodiments, analyzed based on a set of corresponding throttling tiers to determine whether the alert satisfies a set of throttling conditions associated with the set of throttling tiers. For instance, a predefined mapping is used to extract a set of identifiers from alerts associated with a container orchestration system, such as, but not limited to, a cluster-level identifier, a workload-level identifier, and/or a container-level identifier. In embodiments, tier-based alert throttling is performed on the alerts by determining whether a throttling condition associated with a cluster-level throttling tier is satisfied for the cluster-level identifier, a throttling condition associated with a workload-level throttling tier is satisfied for the workload-level identifier, and/or a throttling condition associated with a container-level tier is satisfied for the container-level identifier.

In embodiments, alerts are throttled when one or more of the set of throttling conditions of the corresponding throttling tiers are satisfied. In embodiments, the satisfaction of a single throttling condition associated with a single throttling tier of the set of throttling tiers causes the alert to be throttled and prevents transmission of the alert to an alert recipient. In such an embodiment, the alert is transmitted to the alert recipient when the alert does not satisfy any of the set of throttling conditions of the corresponding set of throttling tiers. In embodiments, alerts are throttled based on the alerts satisfying a predetermined number and/or predetermined percentage of the set of throttling conditions.

In embodiments, the set of extracted keys or identifiers are provided to a tier database (DB) service to determine whether an alert satisfies a set of throttling conditions of a corresponding set of throttling tiers. In embodiments, the tier DB service maintains a set of counters for the set of extracted keys or identifiers in association with the corresponding throttling tiers. For instance, the tier DB service creates an entry in the tier DB for the extracted key or identifier when the extracted key or identifier is first encountered, and increments a counter associated with the entry when alerts associated with the extracted key or identifier is transmitted. In embodiments, the tier DB service determines whether an alert satisfies a set of throttling conditions of a corresponding set of throttling tiers by comparing the counter values to the permit limits associated with the corresponding throttling tiers. In embodiments, the tier DB service returns a set of determinations that are respectively indicative of whether the alert should be throttled by the set of throttling tiers.

In embodiments, the tier DB service controls the number of alerts associated with a particular key or identifier that are transmitted during a predetermined time window in various ways, such as, but not limited to, based on a timeout period, based on a sliding time window, and/or the like. In embodiment, when an alert is throttled by a particular throttling tier, the tier DB service prevents transmission of alerts associated with the key or identifier corresponding to the throttled throttling tier for a predetermined timeout period determined based on the time window associated with the throttling tier. In embodiments, upon the expiration of the timeout period, the tier DB service resets the counter associated with the key or identifier corresponding to the throttled throttling tier by, for example, but not limited to, resetting the counter to zero or deleting the counter from the tier DB. In embodiments, an alert throttling is performed by tracking the number of alerts associated with a key that are transmitted during a sliding time window that is determined based on the time window associated with the throttling tier. For instance, when the number of alerts that are transmitted during a sliding time window exceeds the permit limit associated with the throttling tier, no further alerts associated with the key are transmitted, and when the number of alerts that are transmitted during a sliding time window falls under the permit limit, alerts associated with the key may again be transmitted.

These and further embodiments enable the functionality described above and additional functionality. Such embodiments are described in further detail as follows.

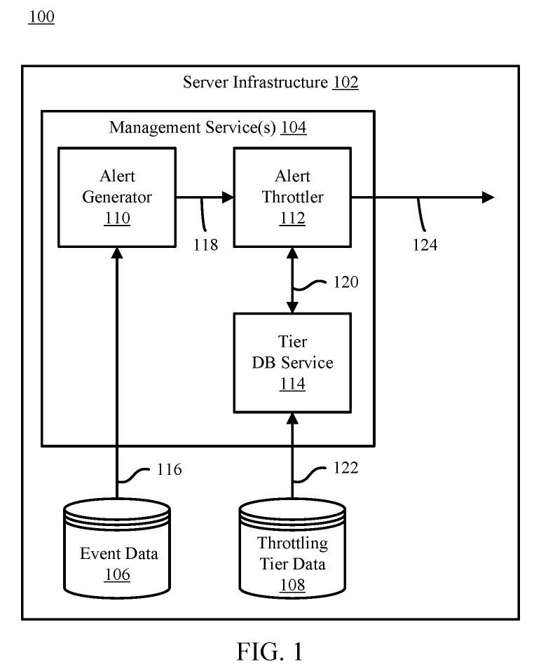

For example, FIG. 1 shows a block diagram of an example system 100 for throttling alerts using throttling tiers, in accordance with an embodiment. As shown in FIG. 1, system 100 includes a server infrastructure 102 that comprises one or more management service(s) 104, event data 106, and throttling tier data 108. Management service(s) 104 further includes an alert generator 110, an alert throttler 112, and a tier database (DB) service 114. System 100 is described in further detail as follows.

Server infrastructure 102 comprises a network-accessible server set (e.g., cloud-based environment or platform). In an embodiment, the underlying resources of server infrastructure 102 are co-located (e.g., housed in one or more nearby buildings with associated components such as backup power supplies, redundant data communications, environmental controls, etc.) to form a datacenter, are distributed across different regions, and/or are arranged in other manners. Various example implementations of server infrastructure 102 are described below in reference to FIG. 9 (e.g., network-based server infrastructure 970, and/or components thereof).

Management service(s) 104 comprise services suitable for performing functions that are ascribed thereto in the following description, as will be appreciated by persons skilled in the relevant art(s), including those mentioned elsewhere herein or otherwise known. In embodiments, management service(s) 104 includes services for tier-based alert throttling.

Event data 106 is configured to store events generated by components internal and/or external to server infrastructure 102. In embodiments, event data 106 comprises events associated with a particular entity (e.g., customer, tenant, etc.), a particular object (e.g., server, cluster, container, etc.), and/or a particular geographic region. In embodiments, event data 106 is provided to alert generator 110 as event data 116.

Throttling tier data 108 is configured to store throttling tier information. In embodiments, throttling tier data 108 stores sets of related throttling tiers and information related to the throttling tiers in the set. In embodiments, throttling tier information includes, but is not limited to, a tier name, a permit limit that limits the number of alerts that may be transmitted on the tier, and a time window that defines a time period during which the number of alerts may be transmitted.

Alert generator 110 is configured to generate an alert 118 based on event data 116 received from event data 106. In embodiments, alert generator 110 generates alert 118 when event data 116 satisfies a rule or trigger. In embodiments, alert generator 110 analyzes a plurality of events in event data 116 to determine whether a rule or trigger is satisfied. In embodiments, alert generator 110 provides alert 118 to alert throttler 112.

Alert throttler 112 is configured to perform tier-based alert throttling based on throttling tier data 108 to control the number of alerts that are transmitted per time window for a set of throttling tiers. In embodiments, alert throttler 112 extracts, from alert 118, a set of keys or identifiers, and determines whether a set of throttling conditions associated with the set of throttling tiers are satisfied for the extracted set of key or identifiers. In embodiments, alert throttler 112 exchanges communications 120 with tier DB service 114 to determine whether the set of throttling conditions associated with the set of throttling tiers are satisfied for the extracted set of key or identifiers. For instance, alert throttler 112 provides the set of extracted keys or identifiers to tier DB service 114, and receives, in response, a set of determinations indicative of whether the set of throttling conditions associated with the set of throttling tiers are satisfied for the extracted set of key or identifiers. If the set of throttling conditions are not satisfied for the set of key or identifiers, alert throttler 112 provides alert 118 to an alert recipient as alert 124. If the alert satisfies one or more of the set of throttling conditions, alert throttler 112 does not transmit alert 118 to the alert recipient.

Tier DB service 114 is configured to maintain a set of counters for a set of keys or identifiers in association with a set of corresponding throttling tiers. In embodiments, tier DB service 114 receives, from alert throttler 112, a set of keys or identifiers extracted from alert 118. In embodiments, tier DB service 114 increments the set of counters associated with the set of key or identifier when alert 118 is transmitted. In embodiments, tier DB service 114 creates entries for keys or identifiers when entries does not already exist. In embodiments, tier DB service 114 accesses throttling tier information 122 from throttling tier data 108. In embodiments, tier DB service 114 determines whether an alert satisfies a set of throttling conditions of a corresponding set of throttling tiers by comparing the values of the set of counters to the permit limits associated with the corresponding throttling tiers. In embodiments, the DB service returns a set of determinations that are respectively indicative of whether the alert should be throttled by the set of throttling tiers. In embodiments, tier DB service 114 comprises a Redis service.

In embodiments, tier DB service 114 controls the number of alerts associated with a particular key or identifier that are transmitted during a predetermined time window based on a timeout period. For instance, when an alert is throttled by a particular throttling tier, tier DB service 114 prevents transmission of alerts associated with the key or identifier corresponding to the throttled throttling tier for a predetermined timeout period determined based on the time window associated with the throttling tier. In embodiments, upon the expiration of the timeout period, tier DB service 114 resets the counter associated with the key or identifier corresponding to the throttled throttling tier by, for example, but not limited to, resetting the counter to zero or deleting the counter from the tier DB.

In embodiments, tier DB service 114 controls the number of alerts associated with a particular key or identifier that are transmitted during a predetermined time window by purging an entry associated with the particular key or identifier upon the expiration of the predetermined time window. For instance, tier DB service 114 creates an entry for the particular key or identifier when the key or identifier is first encountered, and purges the entry after the predetermined time window lapses. In embodiments, tier DB service 114 maintains a count of the number of alerts associated with the key or identifier that are transmitted during predetermined time window, which corresponds to the existence of the entry. Upon expiration of the predetermined time window, tier DB service 114 purges the entry, effectively resetting the counter.

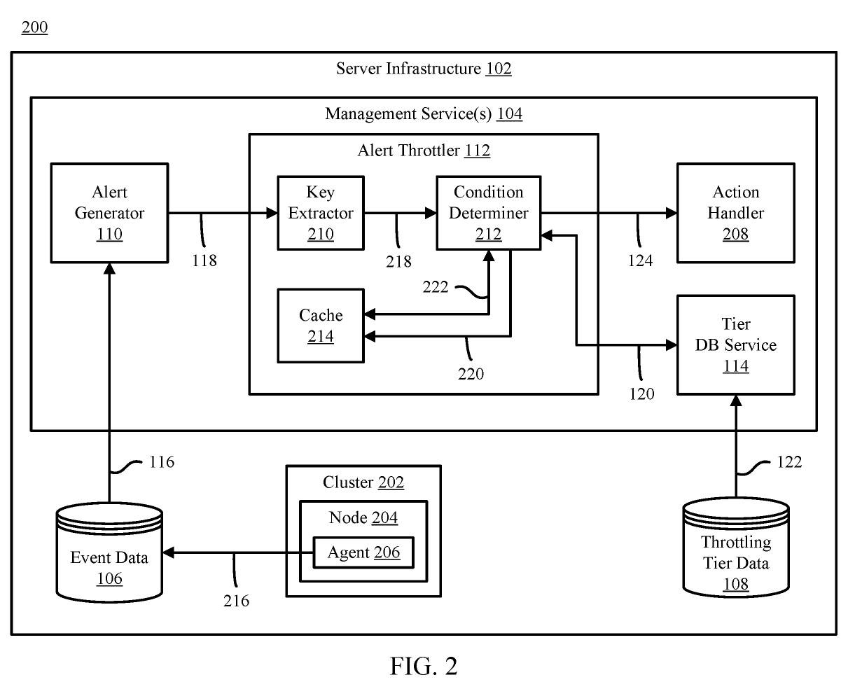

Embodiments described herein may operate in various ways to perform key-based throttling of alerts using throttling tiers. For instance, FIG. 2 shows a block diagram of an example system 200 for key-based throttling of alerts using throttling tiers, in accordance with an embodiment. As shown in FIG. 2, system 200 comprises server infrastructure 102, management service(s) 104, event data 106, throttling tier data 108, alert generator 110, alert throttler 112, and tier DB service 114. System 200 further comprises a cluster 202 that includes a node 204, which includes an agent 206. Management service(s) 104 further includes an action handler 208. Alert throttler 112 further includes a key extractor 210, a condition determiner 212, and a cache 214. System 200 is described in further detail as follows.

Cluster 202 comprise a group of interconnected computers (nodes) that work together to perform computing tasks. In embodiments, cluster 202 include, but are not limited to, computing clusters, container clusters, Kubernetes clusters, and/or the like. In embodiments, an orchestration platform (not shown), such as, but not limited to, Kubernetes, Docker Swarm, Apache Mesos, and/or the like, manages deployment, scaling, and/or operation of containerized applications on cluster 202. Various example implementations of cluster 202 are described below in reference to FIG. 9 (e.g., clusters 972, and/or components thereof).

Node 204 comprises a node of cluster 202 and is configured to execute one or more applications deployed thereon. Various example implementations of node 204 are described below in reference to FIG. 9 (e.g., node 974, node 946, and/or components thereof).

Agent 206 comprises an application deployed onto node 204 that is configured to provide event data 216 associated with cluster 202 and/or node 204 to event data 106 for storage thereon. Various example implementations of agent 206 are described below in reference to FIG. 9 (e.g., application programs 976, and/or components thereof).

Action handler 208 is configured to receive alert 124 from alert throttler 112 and perform an action associated with alert 124, such as, but not limited to, providing alert 124 to a user, performing a remedial action associated with alert 124, terminating an instance and/or process associated with alert 124, and/or the like.

Key extractor 210 is configured to extract a set of keys or identifiers 218 from alert 118. In embodiments, key extractor 210 employs a mapping associated with a particular type of alert to parse alert 118 and to extract the set of keys or identifiers 218 from alert 118. In embodiments, key extractor 210 provides the set of keys or identifiers 218 to condition determiner 212 for analysis.

Condition determiner 212 is configured to determine whether a set of throttling conditions corresponding to a set of throttling tiers is satisfied for the set of keys or identifiers 218. In embodiments, condition determiner 212 exchanges communications 120 with tier DB service 114 to determine whether the set of throttling conditions associated with the set of throttling tiers are satisfied for the set of key or identifiers 218. For instance, condition determiner 212 provides the set of keys or identifiers 218 to tier DB service 114, and receives, in response, a set of determinations indicative of whether the set of throttling conditions associated with the set of throttling tiers are satisfied for the extracted set of key or identifiers. If the set of throttling conditions are not satisfied for the set of key or identifiers, condition determiner 212 provides alert 124 to action handler 208. If the alert satisfies one or more of the set of throttling conditions, condition determiner 212 does not transmit alert 118.

Cache 214 is configured to store a local copy of information maintained by tier DB service 114 in order to reduce the amount of communications between condition determiner 212 and tier DB service 114. In embodiments, condition determiner 212 receives counter information 220 from tier DB service 114 through communications 120 and stores counter information 220 in cache 214. In embodiments, condition determiner 212 determines whether a set of throttling conditions corresponding to a set of throttling tiers is satisfied for the set of keys or identifiers 218 by accessing and/or updating counter information 220 in cache 214 via communications 222.

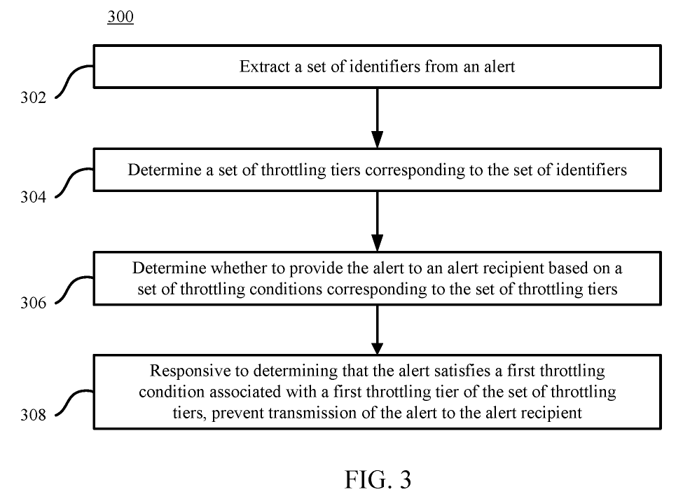

Embodiments described herein may operate in various ways to perform key-based throttling of alerts using throttling tiers. For instance, FIG. 3 depicts a flowchart 300 of a process for key-based throttling of alerts using throttling tiers, in accordance with an embodiment. Server infrastructure 102, management service(s) 104, alert throttler 112, tier DB service 114, action handler 208, key extractor 210, condition determiner 212, and/or cache 214 may, for example, operate according to flowchart 300. Note that not all steps of flowchart 300 need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a set of identifiers is extracted from an alert. For example, key extractor 210 extracts the set of keys or identifiers 218 from alert 118, and provides the extracted set of keys or identifiers 218 to condition determiner 212.

In step 304, a set of throttling tiers corresponding to the set of identifiers is determined. For example, tier DB service accesses throttling tier information from throttling tier data 108.

In step 306, it is determined whether the alert satisfies a set of throttling conditions corresponding to the set of throttling tiers. For example, tier DB service 114 determines whether alert 118 satisfies a set of throttling conditions of a corresponding set of throttling tiers by comparing values of a set of counters corresponding to the set of keys or identifiers 218 to the permit limits associated with the corresponding throttling tiers.

In step 308, responsive to determining that the alert satisfies a first throttling condition corresponding to a first throttling tier of the set of throttling tiers, the alert is prevented from transmission to the alert recipient. For example, condition determiner 212 does not provide alert 124 to action handler 208.

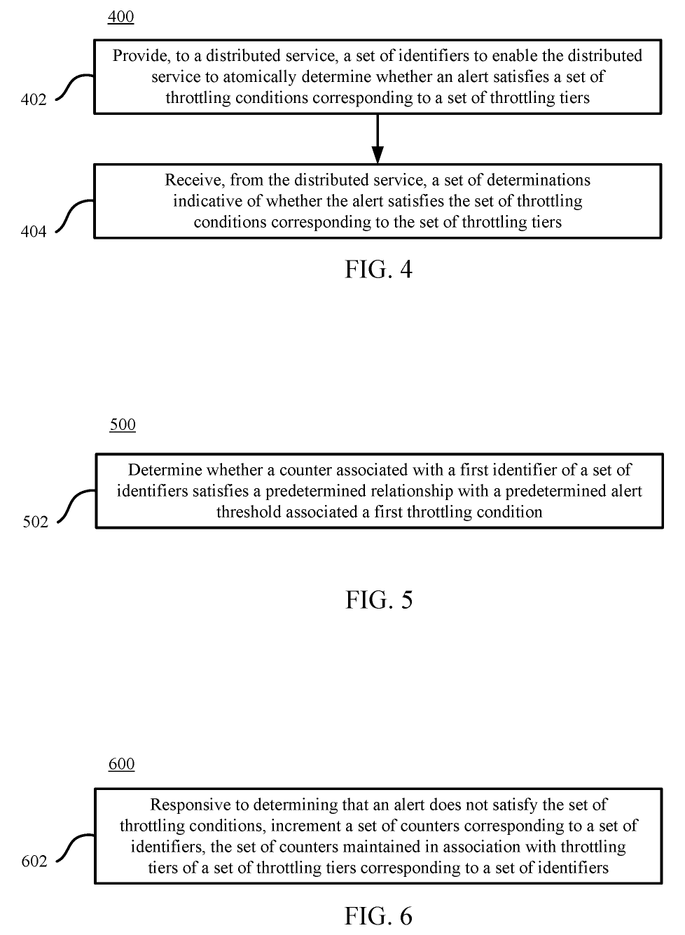

Embodiments described herein may operate in various ways to check alert throttling conditions using a distributed service. For instance, FIG. 4 depicts a flowchart 400 of a process for checking alert throttling conditions using a distributed service, in accordance with an embodiment. Server infrastructure 102, management service(s) 104, alert throttler 112, tier DB service 114, and/or condition determiner 212 may, for example, operate according to flowchart 400. Flowchart 400 is described as follows with respect to FIGS. 1 and 2 for illustrative purposes.

Flowchart 400 starts at step 402. In step 402, the set of identifiers is provided to a distributed service to enable the distributed service to determine whether the alert satisfies the set of throttling conditions corresponding to the set of throttling tiers. For example, alert throttler 112 provides the set of extracted keys or identifiers 218 to tier DB service 114 via communications 120.

In step 404, a set of determinations is received from the distributed service, the set of determinations indicative of whether the alert satisfies the set of throttling conditions corresponding to the set of throttling tiers. For example, condition determiner 212 receives, from tier DB service 114 via communications 120, a set of determinations indicative of whether the set of throttling conditions associated with the set of throttling tiers are satisfied for the extracted set of key or identifiers.

Embodiments described herein may operate in various ways to determine whether an alert throttling condition is satisfied. For instance, FIG. 5 depicts a flowchart 500 of a process for determining whether an alert throttling condition is satisfied, in accordance with an embodiment. Server infrastructure 102, management service(s) 104, alert throttler 112, tier DB service 114, and/or condition determiner 212 may, for example, operate according to flowchart 500. Flowchart 500 is described as follows with respect to FIG. 1 and 2 for illustrative purposes.

Flowchart 500 starts at step 502. In step 502, it is determined whether a counter associated with a first identifier of the set of identifiers satisfies a predetermined relationship with a predetermined alert threshold associated with first throttling condition. For example, tier DB service 114 determines whether alert 118 satisfies a set of throttling conditions corresponding to a set of throttling tiers by comparing the values of a set of counters associated with the set of keys or identifier 118 to permit limits associated with the corresponding throttling tiers.

Embodiments described herein may operate in various ways to increment alert throttling counters. For instance, FIG. 6 depicts a flowchart 600 of a process for incrementing alert throttling counters, in accordance with an embodiment. Server infrastructure 102, management service(s) 104, alert throttler 112, tier DB service 114, and/or condition determiner 212 may, for example, operate according to flowchart 600. Flowchart 600 is described as follows with respect to FIGS. 1 and 2 for illustrative purposes.

Flowchart 600 starts at step 602. In step 602, responsive to determining that the alert does not satisfy the set of throttling conditions, a set of counters corresponding to the set of identifiers is incremented, the set of counters maintained in association with throttling tiers of the set of throttling tiers corresponding to the set of identifiers. For example, tier DB service 114 increments a set of counters associated with the set of keys or identifier 118 when alert 124 is transmitted.

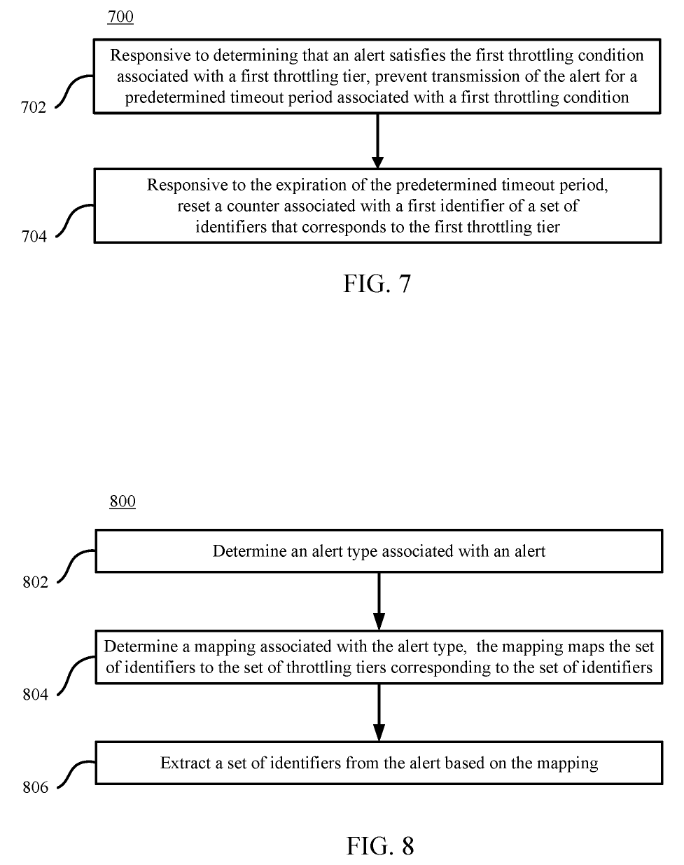

Embodiments described herein may operate in various ways to throttle alerts associated with a throttling tier. For instance, FIG. 7 depicts a flowchart 700 of a process for throttling alerts associated with a throttling tier, in accordance with an embodiment. Server infrastructure 102, management service(s) 104, alert throttler 112, tier DB service 114, and/or condition determiner 212 may, for example, operate according to flowchart 700. Flowchart 700 is described as follows with respect to FIGS. 1 and 2 for illustrative purposes.

Flowchart 700 starts at step 702. In step 702, responsive to determining that the alert satisfies the first throttling condition associated with the first throttling tier, transmission of alerts associated with a first identifier corresponding to the first throttling tier are prevented for a predetermined timeout period associated with the first throttling condition. For example, when alert 118 is throttled by a particular throttling tier, tier DB service 114 prevents transmission of alerts associated with the key or identifier corresponding to the particular throttling tier for a predetermined timeout period determined based on the time window associated with the particular throttling tier.

In step 704, responsive to the expiration of the predetermined timeout period, a counter associated with a first identifier of the set of identifiers that corresponds to the first throttling tier is reset. For example, upon the expiration of the timeout period, tier DB service 114 resets the counter associated with the key or identifier corresponding to the throttled throttling tier by, for example, but not limited to, resetting the counter to zero or purging the counter from tier DB service 114.

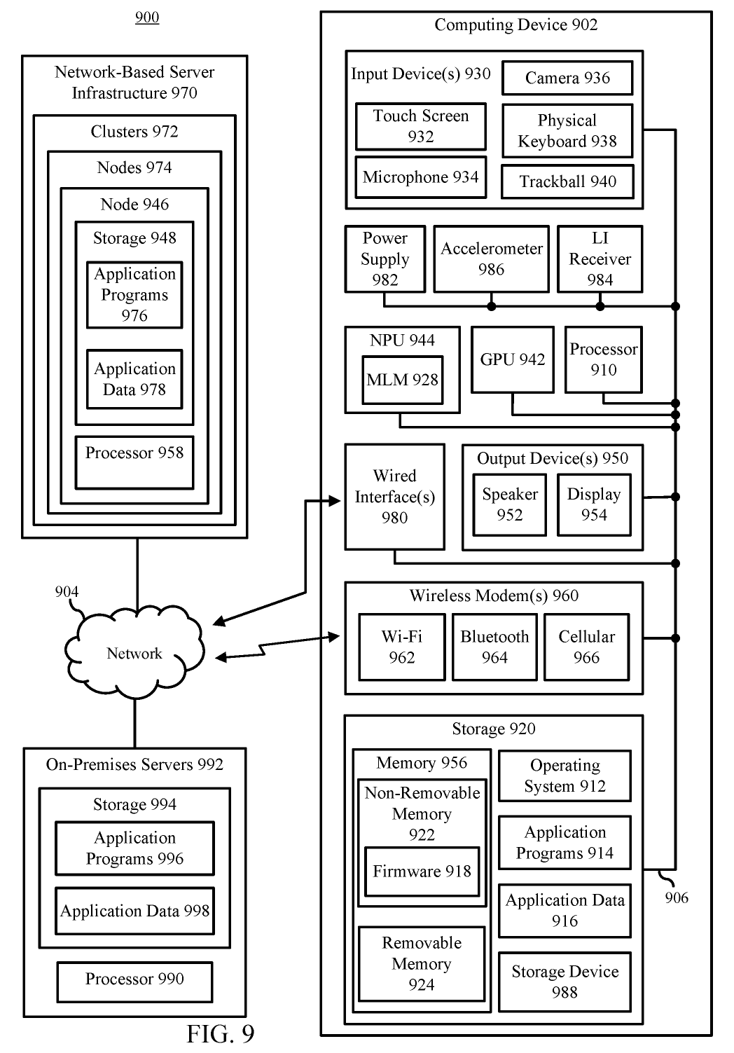

Embodiments described herein may operate in various ways to extract keys from an alert. For instance, FIG. 8 depicts a flowchart 800 of a process for extracting keys from an alert, in accordance with an embodiment. Server infrastructure 102, management service(s) 104, alert throttler 112, and/or key extractor 210 may, for example, operate according to flowchart 800. Note that not all steps of flowchart 800 need to be performed in all embodiments, and in some embodiments, the steps of flowchart 800 may be performed in different orders than shown. Flowchart 800 is described as follows with respect to FIGS. 1 and 2 for illustrative purposes.

Flowchart 800 starts at step 802. In step 802, an alert type associated with the alert is determined. For example, key extractor 210 determines an alert type associated with alert 118.

In step 804, a mapping associated with the alert type is determined, the mapping maps the set of identifiers to the set of throttling tiers corresponding to the set of identifiers. For example, key extractor 210 determines a mapping associated with the determined alert type.

In step 806, a set of identifiers is extracted based on the mapping. For example, key extractor 210 extracts the set of keys or identifiers 218 from alert 118 based on the determined mapping.

### III. Example Mobile Device and Computer System Implementation

Server infrastructure 102, management service(s) 104, event data 106, throttling data 108, alert generator 110, alert throttler 112, tier DB service 114, cluster 202, node 204, agent 206, action handler 208, key extractor 210, condition determiner 212, cache 214, and/or the components described therein and/or the steps of flowcharts 300, 400, 500, 600, 700, and/or 800 are implemented in hardware, or hardware combined with one or both of software and/or firmware. For example, management service(s) 104, event data 106, throttling data 108, alert generator 110, alert throttler 112, tier DB service 114, agent 206, action handler 208, key extractor 210, condition determiner 212, cache 214, and/or the components described therein, and/or the steps of flowcharts 300, 400, 500, 600, 700, and/or 800 are each implemented as computer program code/instructions configured to be executed in one or more processors and stored in a computer readable storage medium. Alternatively, server infrastructure 102, management service(s) 104, event data 106, throttling data 108, alert generator 110, alert throttler 112, tier DB service 114, cluster 202, node 204, agent 206, action handler 208, key extractor 210, condition determiner 212, cache 214, and/or the components described therein, and/or the steps of flowcharts 300, 400, 500, 600, 700, and/or 800 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 9. FIG. 9 shows a block diagram of an exemplary computing environment 900 that includes a computing device 902. Computing device 902 is an example of server infrastructure 102, cluster 202, node 204, and/or components described therein, which each include one or more of the components of computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc. In examples, network 904 includes one or more wired and/or wireless portions. In some examples, network 904 additionally or alternatively includes a cellular network for cellular communications. Computing device 902 is described in detail as follows.

Computing device 902 can be any of a variety of types of computing devices. Examples of computing device 902 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 902 is a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, a graphics processing unit (GPU) 942, a neural processing unit (NPU) 944, one or more input devices 930, one or more output devices 950, one or more wireless modems 960, one or more wired interfaces 980, a power supply 982, a location information (LI) receiver 984, and an accelerometer 986. Storage 920 includes memory 956, which includes non-removable memory 922 and removable memory 924, and a storage device 988. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 930 includes a touch screen 932, a microphone 934, a camera 936, a physical keyboard 938, and a trackball 940. Not all components of computing device 902 shown in FIG. 9 are present in all embodiments, additional components not shown may be present, and in a particular embodiment any combination of the components are present. In examples, components of computing device 902 are mounted to a circuit card (e.g., a motherboard) of computing device 902, integrated in a housing of computing device 902, or otherwise included in computing device 902. The components of computing device 902 are described as follows.

In embodiments, a single processor 910 (e.g., central processing unit (CPU), microcontroller, a microprocessor, signal processor, ASIC (application specific integrated circuit), and/or other physical hardware processor circuit) or multiple processors 910 are present in computing device 902 for performing such tasks as program execution, signal coding, data processing, input/output processing, power control, and/or other functions. In examples, processor 910 is a single-core or multi-core processor, and each processor core is single-threaded or multithreaded (to provide multiple threads of execution concurrently). Processor 910 is configured to execute program code stored in a computer readable medium, such as program code of operating system 912 and application programs 914 stored in storage 920. The program code is structured to cause processor 910 to perform operations, including the processes/methods disclosed herein. Operating system 912 controls the allocation and usage of the components of computing device 902 and provides support for one or more application programs 914 (also referred to as “applications” or “apps”). In examples, application programs 914 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 910 includes one or more general processors (e.g., CPUs) configured with or coupled to one or more hardware accelerators, such as one or more NPUs 944 and/or one or more GPUs 942.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) present to communicatively couple processor 910 to various other components of computing device 902, although in other embodiments, an alternative bus, further buses, and/or one or more individual signal lines is/are present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 988, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 922 includes main memory and is separate from or fabricated in a same integrated circuit as processor 910. As shown in FIG. 9, non-removable memory 922 stores firmware 918 that is present to provide low-level control of hardware. Examples of firmware 918 include BIOS (Basic Input/Output System, such as on personal computers) and boot firmware (e.g., on smart phones). In examples, removable memory 924 is inserted into a receptacle of or is otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 988 are present that are internal and/or external to a housing of computing device 902 and are or are not removable. Examples of storage device 988 include a hard disk drive, a SSD, a thumb drive (e.g., a USB (Universal Serial Bus) flash drive), or other physical storage device.

One or more programs are stored in storage 920. Such programs include operating system 912, one or more application programs 914, and other program modules and program data. Examples of such application programs include computer program logic (e.g., computer program code/instructions) for implementing management service(s) 104, event data 106, throttling data 108, alert generator 110, alert throttler 112, tier DB service 114, agent 206, action handler 208, key extractor 210, condition determiner 212, cache 214, and/or each of the components described therein, as well as any of flowcharts 300, 400, 500, 600, 700, and/or 800, and/or any individual steps thereof.

Storage 920 also stores data used and/or generated by operating system 912 and application programs 914 as application data 916. Examples of application data 916 include web pages, text, images, tables, sound files, video data, and other data. In examples, application data 916 is sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 902 through one or more input devices 930 and receives information from computing device 902 through one or more output devices 950. Input device(s) 930 includes one or more of touch screen 932, microphone 934, camera 936, physical keyboard 938 and/or trackball 940 and output device(s) 950 includes one or more of speaker 952 and display 954. Each of input device(s) 930 and output device(s) 950 are integral to computing device 902 (e.g., built into a housing of computing device 902) or are external to computing device 902 (e.g., communicatively coupled wired or wirelessly to computing device 902 via wired interface(s) 980 and/or wireless modem(s) 960). Further input devices 930 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 displays information, as well as operating as touch screen 932 by receiving user commands and/or other information (e.g., by touch, finger gestures, virtual keyboard, etc.) as a user interface. Any number of each type of input device(s) 930 and output device(s) 950 are present, including multiple microphones 934, multiple cameras 936, multiple speakers 952, and/or multiple displays 954.

In embodiments where GPU 942 is present, GPU 942 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 942 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 944 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 928. In an example, NPU 944 is configured for a data-driven parallel computing and is highly efficient at processing massive multimedia data such as videos and images and processing data for neural networks. NPU 944 is configured for efficient handling of AI-related tasks, such as speech recognition, background blurring in video calls, photo or video editing processes like object detection, etc.

In embodiments disclosed herein that implement ML models, NPU 944 can be utilized to execute such ML models, of which MLM 928 is an example. For instance, where applicable, MLM 928 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 944 is used to train MLM 928. To train MLM 928, training data is that includes input features (attributes) and their corresponding output labels/target values (e.g., for supervised learning) is collected. A training algorithm is a computational procedure that is used so that MLM 928 learns from the training data. Parameters/weights are internal settings of MLM 928 that are adjusted during training by the training algorithm to reduce a difference between predictions by MLM 928 and actual outcomes (e.g., output labels). In some examples, MLM 928 is set with initial values for the parameters/weights. A loss function measures a dissimilarity between predictions by MLM 928 and the target values, and the parameters/weights of MLM 928 are adjusted to minimize the loss function. The parameters/weights are iteratively adjusted by an optimization technique, such as gradient descent. In this manner, MLM 928 is generated through training by NPU 944 to be used to generate inferences based on received input feature sets for particular applications. MLM 928 is generated as a computer program or other type of algorithm configured to generate an output (e.g., a classification, a prediction/inference) based on received input features, and is stored in the form of a file or other data structure.

In examples, such training of MLM 928 by NPU 944 is supervised or unsupervised. According to supervised learning, input objects (e.g., a vector of predictor variables) and a desired output value (e.g., a human-labeled supervisory signal) train MLM 928. The training data is processed, building a function that maps new data on expected output values. Example algorithms usable by NPU 944 to perform supervised training of MLM 928 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 928 is an LLM, MLM 928 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user’s ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 928 is trained to learn patterns from unlabeled data. For instance, in embodiments where MLM 928 implements unsupervised learning techniques, MLM 928 identifies one or more classifications or clusters to which an input belongs. During a training phase of MLM 928 according to unsupervised learning, MLM 928 tries to mimic the provided training data and uses the error in its mimicked output to correct itself (i.e., correct weights and biases). In further examples, NPU 944 perform unsupervised training of MLM 928 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 944 need not necessarily be present in all ML model embodiments. In embodiments where ML models are present, any one or more of processor 910, GPU 942, and/or NPU 944 can be present to train and/or execute MLM 928.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). In examples, wireless modem 960 also or alternatively includes other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 982, LI receiver 984, accelerometer 986, and/or one or more wired interfaces 980. Example wired interfaces 980 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 980 of computing device 902 provide for wired connections between computing device 902 and network 904, or between computing device 902 and one or more devices/peripherals when such devices/peripherals are external to computing device 902 (e.g., a pointing device, display 954, speaker 952, camera 936, physical keyboard 938, etc.). Power supply 982 is configured to supply power to each of the components of computing device 902 and receives power from a battery internal to computing device 902, and/or from a power cord plugged into a power port of computing device 902 (e.g., a USB port, an A/C power port). LI receiver 984 is useable for location determination of computing device 902 and in examples includes a satellite navigation receiver such as a Global Positioning System (GPS) receiver and/or includes other type of location determiner configured to determine location of computing device 902 based on received information (e.g., using cell tower triangulation, etc.). Accelerometer 986, when present, is configured to determine an orientation of computing device 902.

Note that the illustrated components of computing device 902 are not required or all-inclusive, and fewer or greater numbers of components can be present as would be recognized by one skilled in the art. In examples, computing device 902 includes one or more of a gyroscope, barometer, proximity sensor, ambient light sensor, digital compass, etc. In an example, processor 910 and memory 956 are co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein is stored in storage 920 and executed by processor 910.

In some embodiments, server infrastructure 970 is present in computing environment 900 and is communicatively coupled with computing device 902 via network 904. Server infrastructure 970, when present, is a network-accessible server set (e.g., a cloud-based environment or platform). As shown in FIG. 9, server infrastructure 970 includes clusters 972. Each of clusters 972 comprises a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. In examples, any of nodes 974 is a storage node that comprises a plurality of physical storage disks, SSDs, and/or other physical storage devices that are accessible via network 904 and are configured to store data associated with the applications and services managed by nodes 974.

Each of nodes 974, as a compute node, comprises one or more server computers, server systems, and/or computing devices. For instance, a node 974 in accordance with an embodiment includes one or more of the components of computing device 902 disclosed herein. Each of nodes 974 is configured to execute one or more software applications (or “applications”) and/or services and/or manage hardware resources (e.g., processors, memory, etc.), which are utilized by users (e.g., customers) of the network-accessible server set. In examples, as shown in FIG. 9, nodes 974 includes a node 946 that includes storage 948 and/or one or more of a processor 958 (e.g., similar to processor 910, GPU 942, and/or NPU 944 of computing device 902). Storage 948 stores application programs 976 and application data 978. Processor(s) 958 operate application programs 976 which access and/or generate related application data 978. In an implementation, nodes such as node 946 of nodes 974 operate or comprise one or more virtual machines, with each virtual machine emulating a system architecture (e.g., an operating system), in an isolated manner, upon which applications such as application programs 976 are executed.

In embodiments, one or more of clusters 972 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 972 are included in a datacenter in a distributed collection of datacenters. In embodiments, exemplary computing environment 900 comprises part of a cloud-based platform.

In an embodiment, computing device 902 accesses application programs 976 for execution in any manner, such as by a client application and/or a browser at computing device 902.

In an example, for purposes of network (e.g., cloud) backup and data security, computing device 902 additionally and/or alternatively synchronizes copies of application programs 914 and/or application data 916 to be stored at network-based server infrastructure 970 as application programs 976 and/or application data 978. In examples, operating system 912 and/or application programs 914 include a file hosting service client configured to synchronize applications and/or data stored in storage 920 at network-based server infrastructure 970.

In some embodiments, on-premises servers 992 are present in computing environment 900 and are communicatively coupled with computing device 902 via network 904. On-premises servers 992, when present, are hosted within an organization’s infrastructure and, in many cases, physically onsite of a facility of that organization. On-premises servers 992 are controlled, administered, and maintained by IT (Information Technology) personnel of the organization or an IT partner to the organization. Application data 998 can be shared by on-premises servers 992 between computing devices of the organization, including computing device 902 (when part of an organization) through a local network of the organization, and/or through further networks accessible to the organization (including the Internet). Furthermore, in examples, on-premises servers 992 serve applications such as application programs 996 to the computing devices of the organization, including computing device 902. Accordingly, in examples, on-premises servers 992 include storage 994 (which includes one or more physical storage devices such as storage disks and/or SSDs) for storage of application programs 996 and application data 998 and include a processor 990 (e.g., similar to processor 910, GPU 942, and/or NPU 944 of computing device 902) for execution of application programs 996. In some embodiments, multiple processors 990 are present for execution of application programs 996 and/or for other purposes. In further examples, computing device 902 is configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 is used to implement systems, clients, or devices, or components/subcomponents thereof, disclosed elsewhere herein. In other embodiments, a combination of computing device 902, network-based server infrastructure 970, and/or on-premises servers 992 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 914) are stored in storage 920. Such computer programs can also be received via wired interface(s) 960 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Additional Example Embodiments

In embodiments, a system comprises: a processor; and a memory device comprising program code structured to cause the processor to: extract a set of identifiers from an alert; determine a set of throttling tiers corresponding to the set of identifiers; determine whether the alert satisfies a set of throttling conditions corresponding to the set of throttling tiers; and responsive to determining that the alert satisfies a first throttling condition corresponding to a first throttling tier of the set of throttling tiers, prevent transmission of the alert to an alert recipient.

In embodiments, to determine whether the alert satisfies a set of throttling conditions corresponding to the set of throttling tiers, the program code is structured to further cause the processor to: provide, to a distributed service, the set of identifiers to enable the distributed service to determine whether the alert satisfies the set of throttling conditions corresponding to the set of throttling tiers; and receive, from the distributed service, a set of determinations indicative of whether the alert satisfies the set of throttling conditions corresponding to the set of throttling tiers.

In embodiments, to determine whether the alert satisfies the first throttling condition, the program code is structured to cause the processor to: determine whether a counter associated with a first identifier of the set of identifiers satisfies a predetermined relationship with a predetermined alert threshold associated with first throttling condition.

In embodiments, the program code is structured to further cause the processor to: responsive to determining that the alert does not satisfy the set of throttling conditions, increment a set of counters corresponding to the set of identifiers, the set of counters maintained by throttling tiers of the set of throttling tiers corresponding to the set of identifiers.

In embodiments, the program code is structured to further cause the processor to: responsive to determining that the alert satisfies the first throttling condition associated with the first throttling tier, prevent, for a predetermined timeout period associated with the first throttling condition, transmission of alerts associated with a first identifier corresponding to the first throttling tier.

In embodiments, the program code is structured to further cause the processor to: responsive to the expiration of the predetermined timeout period, reset a counter associated with a first identifier of the set of identifiers that corresponds to the first throttling tier.

In embodiments, to extract a set of identifiers from the alert, the program code is structured to cause the processor to: determine an alert type associated with the alert; determine a mapping associated with the alert type; and extract, based on the mapping, the set of identifiers from the alert, wherein the mapping maps the set of identifiers to the set of throttling tiers corresponding to the set of identifiers.

In embodiments, a method comprises: determining a set of throttling tiers; determining whether the alert satisfies a set of throttling conditions corresponding to the set of throttling tiers; and responsive to determining that the alert satisfies a first throttling condition corresponding to a first throttling tier of the set of throttling tiers, preventing transmission of the alert to an alert recipient.

In embodiments, determining whether the alert satisfies a set of throttling conditions corresponding to the set of throttling tiers comprises: providing, to a distributed service, a set of identifiers extracted from the alert to enable the distributed service to determine whether the alert satisfies the set of throttling conditions corresponding to the set of throttling tiers; and receiving, from the distributed service, a set of determinations indicative of whether the alert satisfies the set of throttling conditions corresponding to the set of throttling tiers.

In embodiments, determining whether the alert satisfies a first throttling condition comprises: determining whether a counter associated with a first identifier of a set of identifiers extracted from the alert satisfies a predetermined relationship with a predetermined alert threshold associated with first throttling condition.

In embodiments, the method further comprises: responsive to determining that the alert does not satisfy the set of throttling conditions, incrementing a set of counters corresponding to a set of identifiers extracted from the alert, the set of counters maintained in association with throttling tiers of the set of throttling tiers corresponding to the set of identifiers.

In embodiments, the method further comprises: responsive to determining that the alert satisfies the first throttling condition associated with the first throttling tier, preventing, for a predetermined timeout period associated with the first throttling condition, transmission of alerts associated with a first identifier corresponding to the first throttling tier.

In embodiments, the method further comprises: responsive to the expiration of the predetermined timeout period, resetting a counter associated with a first identifier of a set of identifiers extracted from the alert that corresponds to the first throttling tier.

In embodiments, the method further comprises: determining an alert type associated with the alert; determining a mapping associated with the alert type; and extracting, based on the mapping, a set of identifiers from the alert, wherein the mapping maps the set of identifiers to the set of throttling tiers corresponding to the set of identifiers.

In embodiments, a computer-readable storage medium comprising executable instructions that are executed by a processor to cause the processor to: extract a set of identifiers from an alert; determine a set of throttling tiers corresponding to the set of identifiers; provide, to a distributed service, the set of identifiers to enable the distributed service to determine whether the alert satisfies a set of throttling conditions corresponding to the set of throttling tiers; receive, from the distributed service, a set of determinations indicative of whether the alert satisfies the set of throttling conditions corresponding to the set of throttling tiers; determine, based on the set of determinations, that the alert satisfies a first throttling condition of the set of throttling conditions corresponding to the set of throttling tiers; and prevent transmission of the alert to an alert recipient.

In embodiments, to determine whether the alert satisfies the first throttling condition, the executable instructions are executed by the processor to cause the processor to: determine whether a counter associated with a first identifier of the set of identifiers satisfies a predetermined relationship with a predetermined alert threshold associated with first throttling condition.

In embodiments, the executable instructions are executed by the processor to cause the processor to: responsive to determining that the alert does not satisfy the set of throttling conditions, increment a set of counters corresponding to the set of identifiers, the set of counters maintained by throttling tiers of the set of throttling tiers corresponding to the set of identifiers.

In embodiments, the executable instructions are executed by the processor to cause the processor to: responsive to determining that the alert satisfies the first throttling condition associated with the first throttling tier, prevent, for a predetermined timeout period associated with the first throttling condition, transmission of alerts associated with a first identifier corresponding to the first throttling tier.

In embodiments, the executable instructions are executed by the processor to cause the processor to: responsive to the expiration of the predetermined timeout period, reset a counter associated with a first identifier of the set of identifiers that corresponds to the first throttling tier.

In embodiments, to extract a set of identifiers from an alert, the executable instructions are executed by the processor to cause the processor to: determine an alert type associated with the alert; determine a mapping associated with the alert type; and extract, based on the mapping, the set of identifiers from the alert, wherein the mapping maps the set of identifiers to the set of throttling tiers corresponding to the set of identifiers.

### V. Conclusion

References in the specification to "one embodiment," "an embodiment," "an example embodiment," etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
a processor; and
a memory device comprising program code structured to cause the processor to:
extract a set of identifiers from an alert;
determine a set of throttling tiers corresponding to the set of identifiers;
determine whether the alert satisfies a set of throttling conditions corresponding to the set of throttling tiers; and
responsive to determining that the alert satisfies a first throttling condition corresponding to a first throttling tier of the set of throttling tiers, prevent transmission of the alert to an alert recipient.

2. The system of claim 1, wherein, to determine whether the alert satisfies a set of throttling conditions corresponding to the set of throttling tiers, the program code is structured to further cause the processor to:
provide, to a distributed service, the set of identifiers to enable the distributed service to determine whether the alert satisfies the set of throttling conditions corresponding to the set of throttling tiers; and
receive, from the distributed service, a set of determinations indicative of whether the alert satisfies the set of throttling conditions corresponding to the set of throttling tiers.

3. The system of claim 1, wherein, to determine whether the alert satisfies the first throttling condition, the program code is structured to cause the processor to:
determine whether a counter associated with a first identifier of the set of identifiers satisfies a predetermined relationship with a predetermined alert threshold associated with first throttling condition.

4. The system of claim 1, wherein, the program code is structured to further cause the processor to:
responsive to determining that the alert does not satisfy the set of throttling conditions, increment a set of counters corresponding to the set of identifiers, the set of counters maintained in association with throttling tiers of the set of throttling tiers corresponding to the set of identifiers.

5. The system of claim 1, wherein, the program code is structured to further cause the processor to:
responsive to determining that the alert satisfies the first throttling condition associated with the first throttling tier, prevent, for a predetermined timeout period associated with the first throttling condition, transmission of alerts associated with a first identifier corresponding to the first throttling tier.

6. The system of claim 5, wherein, the program code is structured to further cause the processor to:
responsive to the expiration of the predetermined timeout period, reset a counter associated with a first identifier of the set of identifiers that corresponds to the first throttling tier.

7. The system of claim 1, wherein, to extract a set of identifiers from the alert, the program code is structured to cause the processor to:
determine an alert type associated with the alert;
determine a mapping associated with the alert type; and
extract, based on the mapping, the set of identifiers from the alert,
wherein the mapping maps the set of identifiers to the set of throttling tiers corresponding to the set of identifiers.

8. A method comprising:
determining a set of throttling tiers;
determining whether the alert satisfies a set of throttling conditions corresponding to the set of throttling tiers; and
responsive to determining that the alert satisfies a first throttling condition corresponding to a first throttling tier of the set of throttling tiers, preventing transmission of the alert to an alert recipient.

9. The method of claim 8, wherein said determining whether the alert satisfies a set of throttling conditions corresponding to the set of throttling tiers comprises:
providing, to a distributed service, a set of identifiers extracted from the alert to enable the distributed service to determine whether the alert satisfies the set of throttling conditions corresponding to the set of throttling tiers; and
receiving, from the distributed service, a set of determinations indicative of whether the alert satisfies the set of throttling conditions corresponding to the set of throttling tiers.

10. The method of claim 8, wherein said determining whether the alert satisfies a first throttling condition comprises:
determining whether a counter associated with a first identifier of a set of identifiers extracted from the alert satisfies a predetermined relationship with a predetermined alert threshold associated with first throttling condition.

11. The method of claim 8, further comprising:
responsive to determining that the alert does not satisfy the set of throttling conditions, incrementing a set of counters corresponding to a set of identifiers extracted from the alert, the set of counters maintained in association with throttling tiers of the set of throttling tiers corresponding to the set of identifiers.

12. The method of claim 8, further comprising:
responsive to determining that the alert satisfies the first throttling condition associated with the first throttling tier, preventing, for a predetermined timeout period associated with the first throttling condition, transmission of alerts associated with a first identifier corresponding to the first throttling tier.

13. The method of claim 12, further comprising:
responsive to the expiration of the predetermined timeout period, resetting a counter associated with a first identifier of a set of identifiers extracted from the alert that corresponds to the first throttling tier.

14. The method of claim 8, further comprising:
determining an alert type associated with the alert;
determining a mapping associated with the alert type; and
extracting, based on the mapping, a set of identifiers from the alert,
wherein the mapping maps the set of identifiers to the set of throttling tiers corresponding to the set of identifiers.

15. A computer-readable storage medium comprising executable instructions that are executed by a processor to cause the processor to:
extract a set of identifiers from an alert;
determine a set of throttling tiers corresponding to the set of identifiers;
provide, to a distributed service, the set of identifiers to enable the distributed service to determine whether the alert satisfies a set of throttling conditions corresponding to the set of throttling tiers;
receive, from the distributed service, a set of determinations indicative of whether the alert satisfies the set of throttling conditions corresponding to the set of throttling tiers;
determine, based on the set of determinations, that the alert satisfies a first throttling condition of the set of throttling conditions corresponding to the set of throttling tiers; and
prevent transmission of the alert to an alert recipient.

16. The computer-readable storage medium of claim 15, wherein, to determine whether the alert satisfies the first throttling condition, the executable instructions are executed by the processor to cause the processor to:
determine whether a counter associated with a first identifier of the set of identifiers satisfies a predetermined relationship with a predetermined alert threshold associated with first throttling condition.

17. The computer-readable storage medium of claim 15, wherein, the executable instructions are executed by the processor to cause the processor to:
responsive to determining that the alert does not satisfy the set of throttling conditions, increment a set of counters corresponding to the set of identifiers, the set of counters maintained in association with throttling tiers of the set of throttling tiers corresponding to the set of identifiers.

18. The computer-readable storage medium of claim 15, wherein, the executable instructions are executed by the processor to cause the processor to:
responsive to determining that the alert satisfies the first throttling condition associated with the first throttling tier, prevent, for a predetermined timeout period associated with the first throttling condition, transmission of alerts associated with a first identifier corresponding to the first throttling tier.

19. The computer-readable storage medium of claim 18, wherein, the executable instructions are executed by the processor to cause the processor to:
responsive to the expiration of the predetermined timeout period, reset a counter associated with a first identifier of the set of identifiers that corresponds to the first throttling tier.

20. The computer-readable storage medium of claim 15, wherein, to extract a set of identifiers from an alert, the executable instructions are executed by the processor to cause the processor to:
determine an alert type associated with the alert;
determine a mapping associated with the alert type; and
extract, based on the mapping, the set of identifiers from the alert,
wherein the mapping maps the set of identifiers to the set of throttling tiers corresponding to the set of identifiers.
